(19) United States
(12) Patent Application Publication
(10) Pub. No.: US 2014/0358784 A1
(43) Pub. Date: Dec. 4, 2014

(54) Method and System for Managing Derivative Work to Promote Voluntary Purchase of Lawful Work

(71) Applicant: Jong Kyun Shin, Seoul (KR)

(72) Inventor: Jong Kyun Shin, Seoul (KR)

(21) Appl. No.: 14/258,535

(22) Filed: Apr. 22, 2014

(30) Foreign Application Priority Data
May 30, 2013 (KR) 10-2013-0061404

(51) Int. Cl. G06Q 50/18; G06Q 20/40

(52) U.S. Cl. CPC G06Q 50/184; G06Q 20/4014
USPC 705/44

(57) ABSTRACT

A method and a system for managing a derivative work are provided, wherein a purchaser is authenticated as a lawful purchaser of a work or work voucher based on purchase information on the work or work voucher received by the system, and the authenticated purchaser is assigned a right to participate in the system for managing the derivative work, thereby essentially protecting a right of a right holder to the work.

### CROSS-REFERENCE TO RELATED APPLICATION

This application claims the priority benefit of Korean Patent Application No. 10-2013-0061404, filed on May 30, 2013, in the Korean Intellectual Property Office, the disclosure of which is incorporated herein by reference.

### BACKGROUND

1. Field of the Invention

The present invention relates to a method and system for managing a derivative work to promote a purchase of a lawful work and to protect a right to the work, and more particularly, to a method and system for registering a derivative work by a purchaser of a lawful work or work voucher and distributing profits from the registration.

2. Description of the Related Art

A derivative work is a production created based on an already existing work by translation, arrangement, transformation, adaptation, image production, and other methods, substantially including any work produced based on an already existing work by translation, arrangement, transformation, adaptation, video production, and other methods irrespective of a name and a form. A right to use a work is any right to appreciate, use, or utilize the work on a range of conditions defined by a right holder of the work. A copyright on a derivative work may belong to a subject who creates the derivative work. Even a creator of a derivative work is not allowed to utilize the derivative work without the consent of a copyright holder of the original work, and in the event that the derivative work is utilized without the consent from the copyright holder of the original work, it may be acknowledged that the creator infringes the rights of the copyright holder of the original work to create derivative works and the right of integrity. Thus, when a person purchases a work created by another, the purchaser may need to seek approval from a copyright holder of an original work according to the Berne Convention so as to utilize a derivative work created by the purchaser based on the purchased work.

That is an understanding of permission may differ from a perspective of a copyright holder of an original work and a copyright holder of a derivative work in terms of use of the derivative work and distribution of profits from the derivative work and thus, a mutual agreement may be necessary.

When creating a derivative work, even a legitimate purchaser of a work or voucher for the work at a reasonable cost may need to obtain the consent of a right holder of an original work to avoid infringement on the rights of the right holder to create derivative works and the right of integrity

### SUMMARY

An aspect of the present invention provides a method and a system for registering and managing a purchaser of a lawful work or work voucher

Another aspect of the present invention also provides a method and a system capable of registering and managing a derivative work.

According to an aspect of the present invention, there is provided a method of managing a work conducted by a derivative work management system that manages a derivative work of a work, the method including receiving purchase information on a purchase of the work or a work voucher for the work, authenticating the purchaser as a lawful purchaser of the work or work voucher by verifying whether the purchaser legitimately purchases the work or work voucher based on the received purchase information, and assigning the authenticated purchaser a right, entitlement, or authority to participate in the derivative work management system with respect to the work under a predetermined range of conditions, wherein the derivative work management system provides the authenticated purchaser with at least one of a benefit, a reward, a profit, a privilege, and an incentive with respect to the derivative work of the work under a predetermined range of conditions.

The purchase may be acquiring a right to the work or the work voucher on a predetermined range of conditions defined by a right holder of the work. The purchase may include acquiring the work or the work voucher for free as allowed by the right holder of the work. The purchase information may include payment information on a payment for the work or the work voucher conducted outside the derivative work management system.

The purchase information may be input to a terminal of a third party by the third party, and relayed by a terminal of the purchaser to be transmitted to the derivative work management system.

When consent is acquired from the purchaser to transmit the purchase information from a terminal of a thud party to the derivative work management system, the purchase information may be transmitted directly from the terminal of the third party to the derivative work management system.

The purchase information may include at least one of a unique identification number, transaction information, a transaction receipt, a delivery receipt, purchase withdrawal information, purchase cancellation information, and payment information on the work or work voucher and include a unique identification number of the purchaser.

The authenticating may include transmitting an authentication result to a terminal of the purchaser, receiving additional purchase information, additionally created by the purchaser not authenticated, on the purchaser and on the work and additionally authenticating the purchaser as a lawful purchaser of the work or work voucher by additionally verifying whether the purchaser legitimately purchases the work or work voucher based on the additional purchase information.

The authenticating may not authenticate a person other than the authenticated purchaser as a lawful purchaser with respect to the work or work voucher having the unique identification number when the purchase information on the work or work voucher having the unique identification number verified to be legitimately purchased by the authenticated purchaser is received again from the person other than the authenticated purchaser.

The authenticating may include arranging the authenticated purchaser in a group selected from a plurality of groups based on an order in which the authenticated purchaser legitimately purchases works or work vouchers managed by the derivative work management system and a history of the authenticated purchaser purchasing other works or work vouchers of a right holder of the work.

The method may further include assigning a temporary participation right to the purchaser, wherein the temporary participation right may be a temporary right to participate in the derivative work management system on a condition that the purchaser is authenticated as a lawful purchaser of the work or work voucher within a predetermined period of time, the temporary participation right may be changed into a confirmed right to participate in the derivative work management system when the purchaser provided with the temporary participation right is authenticated as a lawful purchaser within the predetermined period, and the temporary participation right may be cancelled when the purchaser provided with the temporary participation right is not authenticated as a lawful purchaser within the predetermined period.

The method may further include managing the derivative work, wherein the managing of the derivative work may include assigning the authenticated purchaser a registration right to register a derivative work created by the authenticated purchaser in the derivative work management system, registering the derivative work created by the authenticated purchaser in the derivative work management system, and providing the authenticated purchaser consent of a right holder of the work on application of registered derivative work.

The managing of the derivative work may further include assigning the authenticated purchaser a recommendation right to recommend another derivative work registered in the derivative work management system.

The registering may include receiving a request for registration of the derivative work created by the authenticated purchaser, determining whether the derivative work is equivalent or similar to other derivative works registered in the derivative work management system, and postponing the registration when a determination result is equivalent or similar.

The registration right may be provided differently based on an order in which the authenticated purchaser legitimately purchase works or work vouchers managed by the derivative work management system and a history of the authenticated purchaser purchasing other works or work vouchers of a right holder of the work.

The method may further include distributing a profit generated from the derivative work management system.

The profit may include an application profit from application of the derivative work with the consent, and the application profit may be distributed among the right holder of the work, the authenticated purchaser, another authenticated purchaser who recommends the derivative work, and an administrator of the derivative work management system.

The profit may include an advertising profit from an advertisement on a webpage on which the derivative work is posted, and the advertising profit may be distributed among the right holder of the work, the authenticated purchaser, and an administrator of the derivative work management system.

The derivative work management system may manage the derivative work registered by the authenticated purchaser as a derivative work and manage a derivative work of the derivative work.

According to another aspect of the present invention, there is provided a system for managing a derivative work that manages a derivative work of a work, the system including a transmission and reception unit and a processing unit, wherein the transmission and reception unit receives purchase information on purchase of the work or a work voucher for the work, the processing unit authenticates the purchaser as a lawful purchaser of the work or work voucher by verifying whether the purchaser legitimately purchases the work or work voucher based on the received purchase information and assigns the authenticated purchaser a right, entitlement, or authority to participate in the system with respect to the work under predetermined conditions within a predetermined range, and the system provides the authenticated purchaser with at least one of a benefit, a reward, a profit, a privilege and an incentive with respect to the derivative work of the work under a predetermined range of conditions.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a derivative work management system, a purchase terminal and a third party terminal according to an embodiment;

FIG. 2 illustrates a function of a processing unit of the derivative work management system according to an embodiment;

FIG. 3 illustrates a method of the derivative work management system receiving purchase information according to an embodiment;

FIG. 4 illustrates a derivative work management method performed by the derivative work management system according to an embodiment;

FIG. 5 illustrates a purchaser authentication method of the derivative work management method according to an embodiment;

FIG. 6 illustrates a management method of the derivative work management system according to an embodiment;

FIG. 7 illustrates registration of a derivative work according to an embodiment;

FIG. 8 illustrates a method of distributing profits of the derivative work management system according to an embodiment; and

FIG. 9 is illustrates a management method of the derivative work management system using a temporary registration right according to an embodiment.

### DETAILED DESCRIPTION

Hereinafter, exemplary embodiments will be described in detail with reference to the accompanying drawings, wherein like reference numerals refer to like elements throughout.

Various alterations and modifications may be made to the exemplary embodiments, some of which will be illustrated in detail in the drawings and detailed description. However, it should be understood that these embodiments are not construed as limited to the illustrated forms and include all changes, equivalents or alternatives within the idea and the technical scope of this disclosure.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “include” and/or “have,” when used in this specification, specify the presence of stated features, integers, steps, operations, elements, components or combinations thereof but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Like reference numerals in the drawings denote like elements, and redundant descriptions of like elements will be omitted herein. When it is determined a detailed description of a related known function or configuration they may make the purpose of the present invention unnecessarily ambiguous in describing the present invention, the detailed description will be omitted herein.

In the following description, the term “work” may be used to include “work voucher” that is, for example, any right to appreciate the work or to use or utilize the work on conditions with a scope set up by a right holder of the work. For instance, the term “purchaser of a work” may be interpreted as including a “purchaser of a work voucher” and the term “purchase of a work” may be interpreted as including “purchase of a work voucher.”

A system for managing a derivative work that manages a derivative work of an original work (hereinafter, “derivative work management system”) may be used to refer to a system providing benefits and rewards with respect to a derivative work to an authenticated lawful purchaser of the work or a work voucher for the work who purchases the work or work voucher at a reasonable cost. Here, a purchase includes acquiring the work or the work voucher for free as allowed by a right holder of the work according to predetermined conditions and methods, for example, by assigning a right to register or recommend the derivative work and assigning a right to receive a predetermined portion of profits from the derivative work according to a defined condition, which will he described, as the authenticated lawful purchaser is exempted from a responsibility regarding infringement on the right to create derivative works and the right to the integrity in countries having joined the Berne Convention. The derivative work management system may include any system which substantially provides an authenticated lawful purchaser of a work or work voucher with a benefit, a reward, a profit, a privilege, or an incentive with respect to the derivative work in whole or in part, regardless of names or forms.

As used herein, the term “purchase” may mean buying a work or work voucher at a reasonable cost in a legitimate distribution channel allowed by a right holder of the work. Further, the “purchase” may include acquiring a right to use any form of a work allowed by a right holder of the work, not only acquiring ownership of an individual work but also acquiring a temporary right to use a work, such as a temporary service of streaming a work or a time-limited voucher, as allowed by a right holder. The “purchase” also includes acquiring a work or work voucher for free as allowed by a right holder of the work.

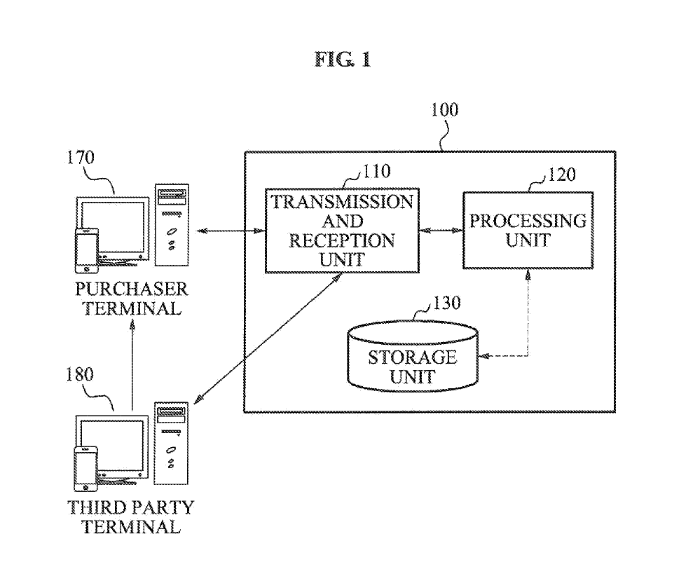

FIG. 1 illustrates a derivative work management system 100, a purchaser terminal 170, and a third party terminal 180 according to an embodiment.

The derivative work management system 100 may include a transmission and reception unit 110, a processing unit 120, and a storage unit 130.

The transmission and reception unit 110 may receive purchase information on a purchaser of a work or a work voucher and on a work or a work voucher through the purchaser terminal 170 or the third party terminal 180.

The purchase information may include not only payment information on a payment for a work or a work voucher completed through the derivative work management system 100, but also payment information on a payment for a work implemented outside the derivative work management system 100. For example, the purchase information may include information on a payment with a credit card, with a debit card and cash, and information on mobile payment.

The purchase information may include information on a purchaser. The purchase information may include information on a person to be authenticated as a purchaser and information on an authenticated purchaser. Hereinafter, the purchase information may refer to information on a purchaser, or information on a purchase.

The purchase information may include at least one of a unique identification number of the work or work voucher, transaction information including a name or number of a purchase transaction account, a purchase transaction type and amount, information on a purchase transaction counterpart, a purchase transaction date, type and identification information on an electronic device, an access record of an electronic device involved in an electronic financial transaction, a record of electronic financial transactions or a record of approved transactions in use of an electronic payment tool, a transaction receipt, a delivery receipt, purchase withdrawal information, purchase cancellation information and payment information, and include a unique identification number of the purchaser. Among the purchase information, the unique identification number of the purchaser may be essential. Further, the transaction information may include the name or number of the purchase transaction account, the purchase transaction type and amount, the information on the purchase transaction counterpart, the purchase transaction date, the type and identification information on the electronic device, the access record of an electronic device involved in the electronic financial transaction, the record of electronic financial transactions and the record of approved transactions in use of an electronic payment tool.

A unique identification number may not necessarily be a number. For example, a unique identification number may include a special sign, a figure, a barcode, a quick response (QR) code, or the like marked on an original Work or a work voucher. A unique identification number may be provided in any name or form as long as one individual original work is distinguishable from another original work. When an original work is an electronic book, a unique identification number may be included in the electronic book as the original work.

The purchase information may be input to the third party terminal 180 by a third party and be relayed to the derivative work management system 100 by the purchaser terminal 170. Further, the purchase information may be transmitted directly from the third party terminal 180 to the derivative work management system 100 with consent of the purchaser.

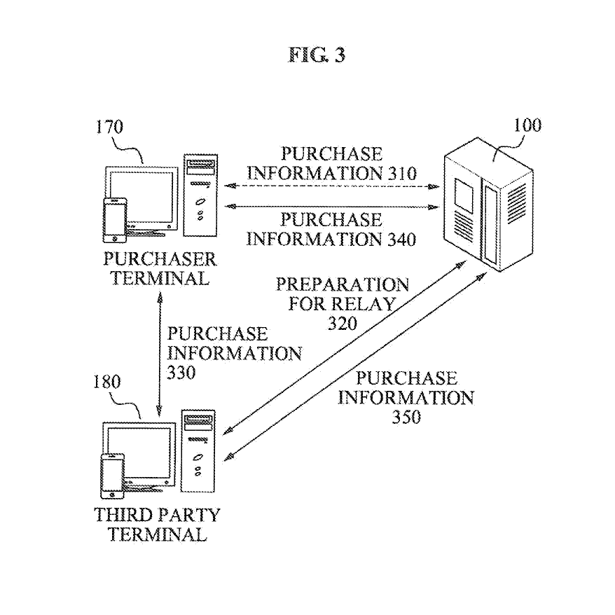

Transmission of the purchase information by the third party terminal 180 will be described in detail with reference to FIG. 3.

The processing unit 120 may encode the received purchase information. The processing unit 120 may store the encoded purchase information for security purposes.

The processing unit 120 may authenticate the purchaser as a lawful purchaser of the work by verifying whether the purchaser legitimately purchases the work or work voucher based on the received purchase information.

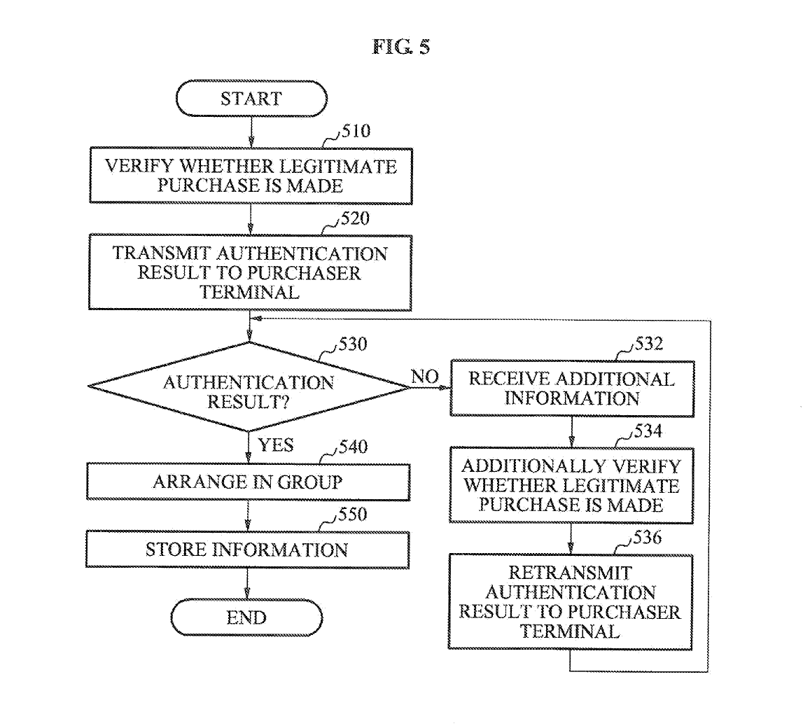

When the purchase information on the work or work voucher having the unique identification number which is verified to be purchased by the authenticated lawful purchaser is input again by a party other than the authenticated purchaser, the party other than the authenticated purchaser is not authenticated as a lawful purchaser with respect to the work or work voucher having the unique identification number. That is when a party authenticated as a lawful purchaser sells, lends or gives a purchased work or work voucher to a third party, the third party who purchases or acquires the work or work voucher from the authenticated purchaser is not authenticated as a lawful purchaser. Thus, authentication of the third party may fail and an authentication result may be transmitted to the purchaser terminal 170. Authentication of the purchaser will be described in detail with reference to FIG. 5.

The processing unit 120 may assign the authenticated purchaser a right to participate in the derivative work management system 100 with respect to the work.

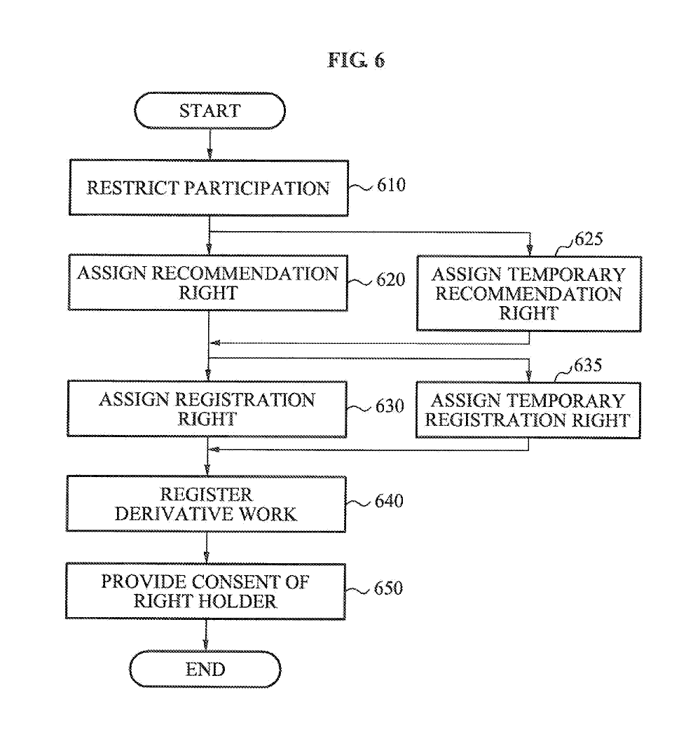

The processing unit 120 may manage the derivative work. Management of the derivative work will be described below in detail with reference to FIG. 6.

The processing unit 120 may distribute profits from the derivative work management system 100.

The profits may include advertising profits front the derivative work management system 100. The advertising profits may be distributed to a right holder of a work, an authenticated purchaser and an administrator of the derivative work management system 100. Further, the advertising profits may be distributed to authenticated purchasers in a differential manner based on orders in which the authenticated purchasers legitimately purchase works or work vouchers managed by the derivative work management system 100 and histories of authenticated purchasers acquiring other works or work vouchers from the right holder of the work. For example, differential distribution enables a purchaser who makes more purchases to receive a greater portion of profits.

The profits may include application profits from application of the derivative work with consent. The application profits may be distributed to the right holder, an authenticated purchaser, a different authenticated purchaser who recommends the derivative work and the administrator of the derivative work management system 100. The application profits may be distributed to different authenticated purchasers who recommend the derivative work in a differential manner based on orders of recommending the derivative work. For instance, differential distribution enables an authenticated purchaser who makes a recommendation in earlier recommending order to receive a greater portion of profits.

The profits may include advertising profits from an advertisement on a webpage on which the derivative work is posted. The advertising profits may be distributed to the right holder, an authenticated purchaser, and the administrator of the derivative work management system 100.

The storage unit 130 may store information and data needed for operations of the derivative work management system 100. For instance, the storage unit 130 may store the purchase information on the purchaser of the work or work voucher and on the work or work voucher, the payment information, information on an authentication result, information on a right to participation, information on profits, and information on distribution of profits.

The foregoing operations and the derivative work management system 100 may be sequentially applied in the same manner to a new derivative work additionally created based on the derivative work by the authenticated lawful purchaser of the derivative work or derivative work voucher, a subsequent derivative work further created based on the new derivative work by an authenticated lawful purchaser of the new derivative work or new derivative work voucher, and ensuing derivative works. That is, the derivative work management system 100 may manage the derivative work as a derivative work, and a subsequent derivative work of the derivative work,

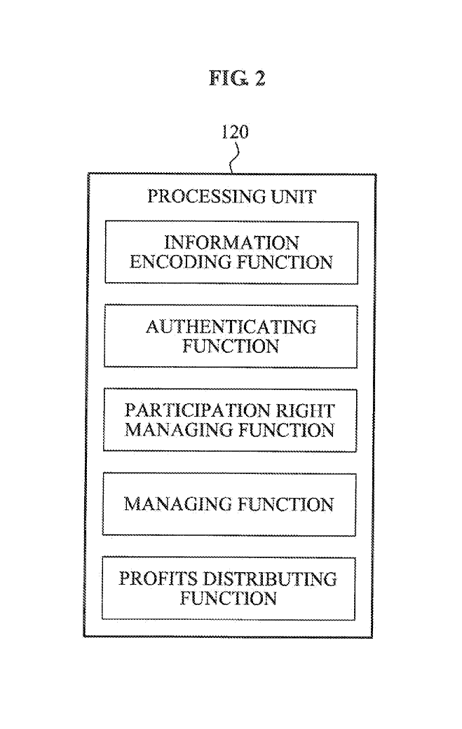

FIG. 2 illustrates a function of the processing unit 120 of FIG. 1.

The processing unit 120 may have an information encoding function, an authenticating function, a participation right managing function, a managing function and a profits distributing function.

For example, as described with reference to FIG. 1, the processing unit 120 may encode the received purchase information, authenticate the purchaser as a lawful purchaser of the work or the work voucher, grant the authenticated purchaser with a right to participate in the derivative work management system 100 with respect to the work, manage a derivative work, and distribute profits from the derivative work management system 100.

FIG. 3 illustrates a method of the derivative work management system receiving purchase information according to an embodiment.

In operation 310, the derivative work management system 100 may receive purchase information directly from the purchaser terminal 170.

In operation 320, the derivative work management system 100 may request preparation for a relay. For instance, the derivative work management system 100 may request the purchase information from the third party terminal 180 so that the purchase information is transmitted through the purchaser terminal 170.

In operation 330 the purchase information may be input to the third party terminal 180 by the third party. Further, the purchase information may be transmitted to the purchaser terminal 170 for a relay.

In operation 340, the transmitted purchase information may be transmitted to the derivative work management system 100.

In operation 350, when consent is acquired from the purchaser to transmit the purchase information from the third part terminal 180 to the derivative work management system 100, the purchase information may be transmitted directly from the third party terminal 180 to the derivative work management system 100.

That is, in operations 320 to 340, the purchase information may be input to the third party terminal 180 by the third party and relayed by the purchaser terminal 170 to be transmitted to the derivative work management system 100, or be transmitted directly from the third party terminal 180 to the derivative work management system 100 with consent from the purchaser.

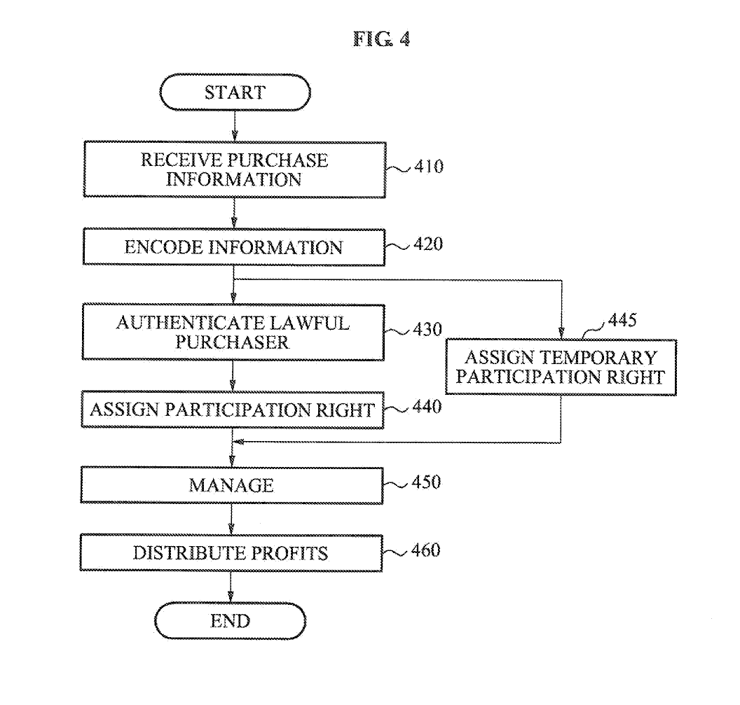

FIG. 4 illustrates a derivative work management method performed by the derivative work management system 100 according to an embodiment.

In operation 410, the transmission and reception unit 110 may receive purchase information on a purchaser of a work or work voucher, and on a work or work voucher.

In operation 420, the processing unit 120 illustrated in FIG. 1 may encode the purchase information.

In operation 430, the processing unit 120 may authenticate the purchaser as a lawful purchaser of the work or work voucher by verifying whether the purchaser legitimately purchases the work or work voucher based on the received purchase information.

In operation 440, the processing unit 120 may assign the authenticated purchaser a right to participate in the derivative work management system 100 with respect to the work.

In operation 445, the processing unit 120 may assign the purchaser a temporary participation right. Here, the temporary participation right may be a temporary right to participate in the derivative work management system 100 on a condition that a purchaser is authenticated as a lawful purchaser of the work or work voucher within a predetermined period of time.

When a purchaser provided with a temporary participation right is authenticated as a lawful purchaser within the predetermined period, the processing unit 120 may change the temporary participation right into a confirmed right to participation in the derivative work management system 100. Further, when a purchaser provided with a temporary participation right is not authenticated as a lawful purchaser within the predetermined period, the processing unit 120 may cancel the temporary participation right.

Operation 450 is conducted after operation 445.

In operation 450, the processing unit 120 may manage the derivative work.

In operation 460, the processing unit 120 may distribute profits from the derivative work management system 100.

As described in operations 410 to 460, the processing unit 120 may authenticate the purchaser as a lawful purchaser of the work or work voucher by verifying whether the purchaser legitimately purchases the work sir work voucher based on the received purchase information, assign the authenticated purchaser a right to participate in the derivative work management system 100 with respect to the work, manage the derivative work, and distribute profits from the derivative work management system 100.

FIG. 5 illustrates a purchaser authentication method of the derivative work management system 100 according to an embodiment.

Authentication operation 430 illustrated in FIG. 4 may include operations 510 to 550.

In operation 510, the processing unit 120 may verify whether the purchaser legitimately purchases the work or work voucher based on the received purchase information. The information on the work or work voucher having a specific identification umber which are confirmed to be legitimately purchased by the authenticated purchaser, may be received again from a person other than the authenticated purchaser When the purchase information on the work or work voucher is received again, the person other than the authenticated purchaser may not be authenticated as a lawful purchaser of the work or work voucher having the specific identification number.

In operation 520, the transmission and reception unit 110 may transmit an authentication result to the purchaser terminal 170. For instance, the transmission and reception unit 110 may transmit the authentication result to the purchaser terminal 170 through an automatic response system (ARS), a texting service, e-mail, or an application.

In operation 530, when the purchase is recognized to be legitimate, the processing unit 120 may perform operation 540. When the purchase is recognized not to be legitimate, the processing unit 120 may perform operation 532.

In operation 532, the transmission and reception unit 110 may receive additional purchase information. The additional purchase information may be additionally generated by an unauthenticated purchaser.

In operation 534, the processing unit 120 may further verify whether the purchaser legitimately purchases the work or work voucher based on the additional purchase information, thereby additionally authenticating the purchaser as a lawful purchaser of the work or work voucher.

In operation 536, the transmission and reception unit may retransmit an authentication result to the purchaser terminal 170. After operation 536, operation 530 may be performed.

In operation 540, the processing unit 120 may arrange the authenticated purchaser in a group selected from a plurality of groups based on an order in which the authenticated purchaser legitimately purchases works or work vouchers managed by the derivative work management system 100 and a history of an authenticated purchaser purchasing other works or work vouchers of the right holder of the work. Here, the groups may be generated by dividing authenticated purchasers based on orders in which the authenticated purchasers legitimately purchase works or work vouchers managed by the derivative work management system 100 and the history of the authenticated purchaser.

In operation 550, the processing unit 120 may store information on the authenticated purchaser in the storage unit 130.

FIG. 6 illustrates a management method of the derivative work management system 100 according to an embodiment.

Management operation 450 illustrated in FIG. 4 may include operations 610 to 650.

In operation 610, the processing unit 120 may restrict participation of an unauthenticated person in the derivative work management system 100 as a whole or partially under a predetermined condition or within a predetermined range.

In operation 620, the processing unit 120 may assign the authenticated purchaser a recommendation right to recommend another derivative work registered in the derivative work management system 100. Here, the recommendation right may be provided in a differential manner based on orders in which authenticated purchasers legitimately purchase works Or work vouchers managed by the derivative work management system 100 and a history of an authenticated purchaser purchasing other works or work vouchers of the right holder of the work. For example, providing the recommendation right in the differential manner may mean that an authenticated purchaser who makes more purchases may have a greater number of rights to recommend other derivative works.

In operation 625, the processing unit 120 may assign a temporary recommendation right to a purchaser. The temporary recommendation right may be a temporary right to recommend another derivative work registered in the derivative work management system 100. The temporary recommendation right may be a temporary right to recommend another derivative work registered in the derivative work management system 100 on a condition that the purchaser is authenticated as a lawful purchaser of the work or work voucher within a predetermined period of time.

When a purchaser provided with a temporary recommendation right is authenticated as a lawful purchaser of the work or work voucher within the predetermined period, the processing unit 120 may change a temporary recommendation of the other derivative work by the purchaser into a confirmed recommendation by the purchaser. Also, when a purchaser provided with a temporary recommendation right is not authenticated as a lawful purchaser of the work or work voucher within the predetermined period, the processing unit 120 may delete or exclude a temporary recommendation of the other derivative work by the purchaser from the derivative work management system 100.

After operation 625, operation 630 or operation 635 may be performed.

In operation 630, the processing unit 120 may assign the authenticated purchaser a registration right to register a derivative work created by the authenticated purchaser in the derivative work management system 100. Here, the registration right may be provided in a differential manner based on orders in which authenticated purchasers legitimately purchase works or work vouchers managed by the derivative work management system 100 and a history of an authenticated purchaser purchasing other works or work vouchers of the right holder of the work. For example, providing the registration right in the differential manner may mean that an authenticated purchaser who makes more purchases may register a greater number of derivative forks.

In operation 635, the processing unit 120 may assign a temporary registration right to a purchaser. Here, the temporary registration right may be provided on a condition that the purchaser is authenticated as a lawful purchaser of the work or work voucher within a predetermined period of time. The temporary registration right may be a temporary right to register a derivative work created by a purchaser not authenticated as a lawful purchaser of the work or work voucher in the derivative work management system 100.

When a purchaser not authenticated as a lawful purchaser of the work or work voucher temporarily registers a derivative work and is authenticated as a lawful purchaser within the predetermined period, the processing unit 120 may definitely register the temporarily registered derivative work in the derivative work management system 100. However, when a purchaser not authenticated as a lawful purchaser of the work or work voucher temporarily registers a derivative work and is not authenticated as a lawful purchaser within the predetermined period, the processing unit 120 may delete or exclude the temporarily registered derivative work from the derivative work management system 100.

In the present embodiment, operation 620 is followed by operation 630. Alternatively, operations 620 and 630 may be performed in parallel. Also, operation 630 is followed by operation 620.

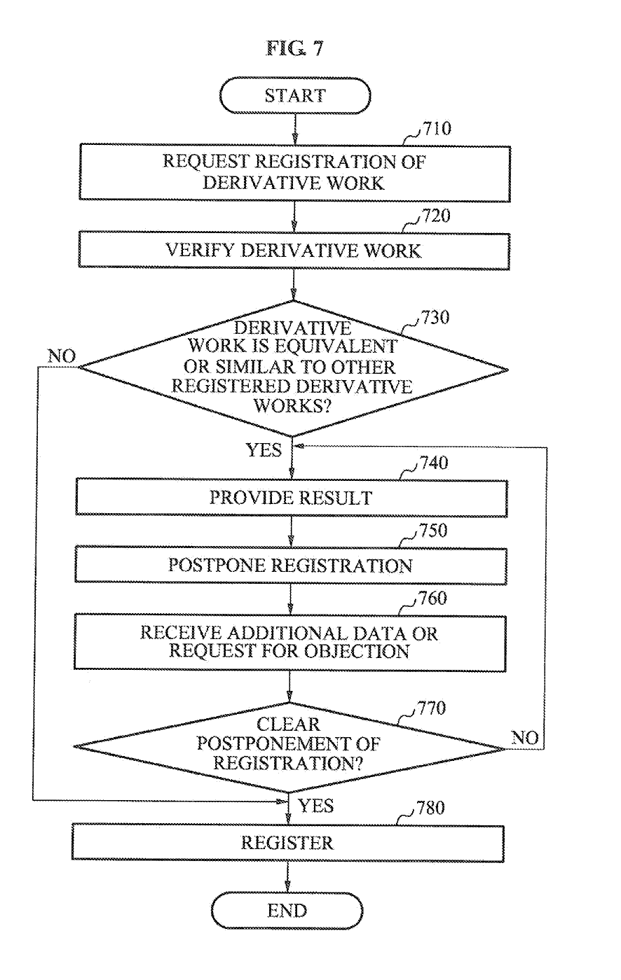

In operation 640, the derivative work created by the authenticated purchaser may be registered in the derivative work management system 100. Registration operation 640 will be described in detail with reference to FIG. 7.

In operation 650, the processing unit 120 may provide the authenticated purchaser consent of a right holder of the work on application of the registered derivative work under predetermined conditions and within a predetermined range set by the right holder of the work. Here, the consent may include a predetermined range and conditions for application. The range of application may be determined based on a recommendation count of the derivative work by other authenticated purchasers and a history of the authenticated purchaser purchasing other works or work vouchers of the right holder.

FIG. 7 illustrates registration of a derivative work according to an embodiment.

Registration operation illustrated in FIG. 6 may include operations 710 to 780,

In operation 710, the transmission and reception unit 110 may receive a request for registration of a derivative work created by an authenticated purchaser.

In operation 720, the processing unit 120 may verify whether the work requested to be registered by the authenticated purchaser, that is, “registration-requested work” is based on a work purchased by the authenticated purchaser.

During verification, the processing unit 120 may verify whether the registration-requested work is produced by translation, arrangement, transformation, adaptation, video production of an original work, or other methods.

For instance, when the registration-requested work is based on sound, the processing unit 120 may compare sounds of the registration-requested work and the original work for verification, thereby verifying whether the registration-requested work is a derivative work based on the work purchased by the purchaser. Specifically, when sound of the registration-requested work has a different pitch from sound of the original work but notes in a selected section have the same variation, the processing unit 120 may verify that the registration-request work is derived from the original work.

When the registration-requested work is based on letters, the processing unit 120 may verify whether words in selected comparative sections of the registration-requested work and the original work are arranged equally. When the words are arranged equally, the processing unit 120 may verify that the registration-request work is derived from the original work.

When the registration-requested work is based on a still image, the processing unit 120 may compare faces, object arrangements and pixel arrangements recognized in still images of the registration-requested work and the original work, thereby verifying whether the registration-requested work is a derivative work of the original work.

When the registration-requested work is based on a video, the processing unit 120 may verify the registration-request work is derived from the original work when the registration-requested work and the original work have identical or similar variations in comparative areas of selected sections of videos.

For instance, the registration-requested work may be a video work based on a sound of the original work. The video work based on the sound of the original work may include, for example, a user created content (UCC). When a video of the registration-requested work includes part of the sound of the original work, the processing unit 120 may verify that the registration-requested work is derived from the original work.

When the registration-requested derivative work is not based on the work purchased by the authenticated purchaser, the processing unit 120 may reject the request for registration. When the registration-requested derivative work is based on the original work purchased by the authenticated purchaser in operation 720, operation 730 may be conducted.

In operation 730, the processing unit 120 may determine whether the registration-requested derivative work is equivalent or similar to other derivative works registered in the derivative work management system 100.

The following methods may be used to determine equivalence or similarity between the registration-requested derivative work and the other registered derivative works.

For example, when the registration-requested derivative work is based on sound, the processing unit 120 may compare sounds of the registration-requested derivative work and the other registered derivative works to determine equivalence or similarity. When the sound of the registration-requested work has a different pitch from sounds of the other registered derivative works but notes in a selected section have the same variation, the processing unit 120 may determine that the registration-requested derivative work is equivalent or similar to the other registered derivative works.

When the registration-requested derivative work is based on letters and words are arranged equally in selected comparative sections of the registration-requested derivative work and the other registered derivative works, the processing unit 120 may determine that the registration-requested derivative work is equivalent or similar to the other registered derivative works.

When the registration-requested derivative work is based on a still image, the processing unit 120 may compare faces, object arrangements and pixel arrangements recognized in still images of the registration-requested derivative work and the other registered derivative works, thereby determining that the registration-requested derivative work is equivalent or similar to the other registered derivative works.

When the registration-requested derivative work is based on a video and the registration-requested derivative work and the other registered derivative works have the same or similar variations in comparative areas of selected sections of videos, the processing unit 120 may determine that the registration-requested derivative work is equivalent or similar to the other registered derivative works.

The registration-requested derivative work may be a video work based on the sound of the original work. When the registration-requested derivative work and the other registered derivative works have the same or similar variations in comparative areas of selected sections of videos, the processing unit 120 may determine that the registration-requested derivative work is equivalent or similar to the other registered derivative works.

When a determination result reveals non-similarity in operation 730, operation 780 may be performed.

When a determination result reveals equivalence or similarity in operation 730, operation 740 may be performed.

In operation 740, when the determination result reveals equivalence or similarity, the processing unit 120 may provide the determination result to the authenticated purchaser. For instance, the transmission and reception unit 110 may transmit the determination result to the purchaser terminal 170 through an ARS, a texting service, e-mail, or an application.

In operation 750, when the determination, result reveals equivalence or similarity, the processing unit 120 may postpone registration.

In operation 760, the transmission and reception unit 110 may receive additional data for registration of the derivative work or a request for an objection to postponement. Here, the additional data or the request for the objection to postponement may be transmitted from the purchaser terminal 170 or the third party terminal 180.

In operation 770, the processing unit 120 may determine whether to clear the postponement of registration based on the received additional data or the objection. In determining whether to clear the postponement of registration, the methods of determining equivalence or similarity used in operation 730 may be used.

When the postponement of registration is cleared in operation 770, operation 780 may be performed. However, when the postponement of registration is retained, operation 740 may be performed.

In operation 780, the processing unit 120 may register the derivative work in the derivative work management system 100.

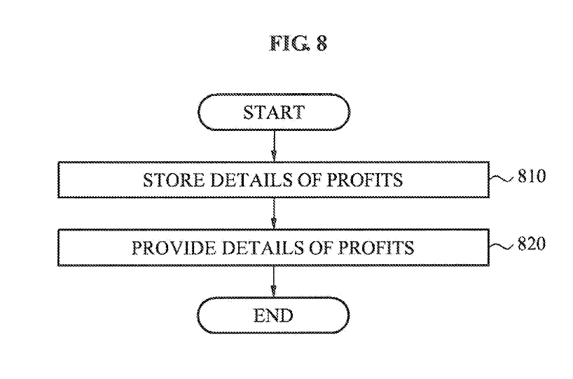

FIG. 8 illustrates a method of distributing profits of the derivative work management system according to an embodiment.

Profits distributing operation 460 illustrated in FIG. 4 may include operations 810 and 820.

In operation 810, the processing unit 120 may store details of the profits in the storage unit 130.

In operation 820, the processing unit 120 may provide the stored details of the profits to at least one of the right holder, an authenticated purchaser, and the administrator of the derivative work management system 100. The transmission and reception unit 110 may transmit the stored details of the profits to the purchaser terminal 170.

The processing unit 120 may store the stored details of the profits in the storage unit 130 and provide the stored details of the profits to at least one of the right holder, an authenticated purchaser and the administrator of the derivative work management system 100.

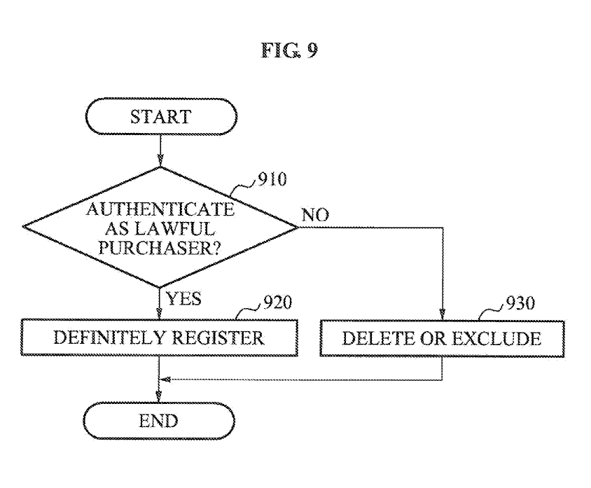

FIG. 9 illustrates a management method of the derivative work management system 100 using a temporary registration right according to an embodiment.

In operation 910, the processing unit 120 may confirm whether an authenticated purchaser is a lawful purchaser of a work or work voucher, which may be correspond to operations 510 to 536 in FIG. 5.

In operation 920, the processing unit 120 may definitely register a temporarily registered derivative work when the authenticated purchaser is authenticated as the lawful purchaser in operation 910.

In operation 930, the processing unit 120 may delete or exclude a temporarily registered derivative work when the unauthenticated purchaser is not authenticated as the lawful purchaser in operation 910.

Operations 910 to 930 may be carried out after operation 445 of assigning the temporary participation right in FIG. 4.

Management operation 450 illustrated in FIG. 4 may include operations 610 to 650 of FIG. 6 and further include operations 910 to 930.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs, and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

A number of examples have been described above. Nevertheless, it should be understood that various modifications may be made. For example, suitable results may be achieved if the described techniques are performed in a different order and/or if components in a described system, architecture, device, or circuit are combined in a different, manner and/or replaced or supplemented by other components or their equivalents. Accordingly, other implementations are within the scope of the following claims.

What is claimed is:

1. A method of managing a work conducted by a derivative work management system that manages a derivative work of a work, the method comprising:
receiving purchase information on a purchase of the work or a work voucher for the work, the purchase information comprising payment information on payment for the work or the work voucher, and a unique identification number of a purchaser of the work or the work voucher;
authenticating the purchaser identified by the unique identification number as a lawful purchaser of the work or the work voucher indicated by the payment information; and
assigning the authenticated purchaser a right, entitlement, or authority with respect to the work to participate in the derivative work management system;
wherein the derivative work management system provides the authenticated purchaser with at least one of a benefit, a reward., a profit, a privilege, and an incentive with respect to the derivative work of the work.

2. The method of claim 1, wherein the purchase is acquiring a right to the work or the work voucher.

3. The method of claim 1, wherein the purchase information comprises the payment information on a payment for the work or the work voucher that is conducted outside the derivative work management system.

4. The method of claim 1, wherein the purchase information is input to a terminal of a third party by the third party; and relayed by a terminal of the purchaser to be transmitted to the derivative work management system.

5. The method of claim 1, wherein when consent is acquired from the purchaser to transmit the purchase information from a terminal of a third party to the derivative work management system, the purchase information is transmitted directly from the terminal of the third party to the derivative work management system.

6. The method of claim 1, wherein the purchase information comprises at least one of a unique identification number, transaction information, a transaction receipt, a delivery receipt, purchase withdrawal information, purchase cancellation information, and payment information on the work or work voucher and comprises the unique identification number of the purchaser.

7. The method of claim 1, wherein the authenticating comprises:
transmitting an authentication result to a terminal of the purchaser;
receiving additional purchase information, additionally created by the purchaser not authenticated, on the purchaser and on the work or work voucher; and
additionally authenticating the purchaser as a lawful purchaser of the work or work voucher by additionally verifying whether the purchaser legitimately purchases the work or work voucher based on the additional purchase information.

8. The method of claim 1, wherein the authenticating does not authenticate a party other than the authenticated purchaser as a lawful purchaser with respect to the work or work voucher having the unique identification number when the purchase information on the work or work voucher having the unique identification number verified to be legitimately purchased by the authenticated purchaser is received again from the party other than the authenticated purchaser.

9. The method of claim 1, wherein the authenticating comprises arranging the authenticated purchaser in a group selected from a plurality of groups based on an order in which the authenticated purchaser legitimately purchases works or work vouchers managed by the derivative work management system and a history of the authenticated purchaser purchasing other works or work vouchers of a right holder of the work.

10. The method of claim 1, further comprising assigning a temporary participation right to the purchaser,
wherein the temporary participation right is a temporary right to participate in the derivative work management system on a condition that the purchaser is authenticated as a lawful purchaser of the work or work voucher within a predetermined period of time,
the temporary participation right is changed to a confirmed right to participate in the derivative work management system when the purchaser provided with the temporary participation right is authenticated as a lawful purchaser within the predetermined period, and
the temporary participation right is cancelled when the purchaser provided with the temporary participation right is not authenticated as a lawful purchaser within the predetermined period.

11. The method of claim 1, further comprising managing the derivative work,
wherein the managing of the derivative work comprises:
assigning the authenticated purchaser a registration right to register a derivative work created by the authenticated purchaser in the derivative work management system;
registering the derivative work created by the authenticated purchaser in the derivative, work management system; and
providing the authenticated purchaser consent of a right holder of the work on the application of registered derivative work.

12. The method of claim 11, wherein the managing of the derivative work further comprises assigning the authenticated purchaser a recommendation right to recommend another derivative work registered in the derivative work management system.

13. The method of claim 11, wherein the registering comprises:
receiving a request for registration of the derivative work created by the authenticated purchaser;
determining whether the derivative work is equivalent or similar to other derivative works registered in the derivative work management system; and
postponing the registration when a determination result is equivalent or similar.

14. The method of claim 11, wherein the registration right is provided differently based on an order in which the authenticated purchaser legitimately purchase works or work vouchers managed by the derivative work management system and a history of the authenticated purchaser purchasing other works or work vouchers of a right holder of the work.

15. The method of claim 11, further comprising distributing a profit generated from the derivative work management system.

16. The method of claim 15, wherein the profit comprises an application profit from application of the derivative work with the consent, and
the application profit is distributed among the right holder of the work, the authenticated purchaser, another authenticated purchaser who recommends the derivative work, and an administrator of the derivative work management system.

17. The method of claim 15, wherein the profit comprises an advertising profit from an advertisement on a webpage on which the derivative work is posted, and
the advertising profit is distributed among the right holder of the work, the authenticated purchaser, and an administrator of the derivative work management system.

18. The method of claim 1, wherein the derivative work management system manages the derivative work registered by the authenticated purchaser as a derivative work and manages a derivative work of the derivative work.

19. A non-transitory computer-readable recording medium recoding a program to implement the method of claim 1.

20. A system for managing a derivative work that manages a derivative work of a work, the system comprising:
a transmission and reception unit; and
a processing unit,
wherein the transmission and reception unit receives purchase information on a purchase of the work or a work voucher for the work, the purchase information comprising payment information on payment for the work or the work voucher, and a unique identification number of a purchaser of the work or the work voucher,
the processing unit authenticates the purchaser identified by the unique identification number as a lawful purchaser of the work or the work voucher indicated by the payment information and assigns the authenticated purchaser a right, entitlement, or authority to participate in the system with respect to the work, and
the system provides the authenticated purchaser with at least one of a benefit, a reward, a profit, a privilege, and an incentive with respect to the derivative work of the work.
